(19) United States
(12) Patent Application Publication
(10) Pub. No.: US 2026/0279055 A1
(43) Pub. Date: Sep. 17, 2026

(54) VIDEO METADATA GENERATION USING VIDEO CHUNKING AND DATA FUSION

(71) Applicant: NVIDIA Corporation, Santa Clara, CA (US)

(72) Inventors: Bilva Bhalchandra Navathe, Pune (IN); Fangyu Li, San Jose, CA (US); Joonhwa Shin, Santa Clara, CA (US)

(21) Appl. No.: 19/266,510

(22) Filed: Jul. 11, 2025

Related U.S. Application Data
(60) Provisional application No. 63/772,141, filed on Mar. 14, 2025.

(51) Int. Cl. G06V 20/40; G06T 7/246; G06T 7/70; G06V 10/74

(52) U.S. Cl. CPC G06V 20/49; G06T 7/248; G06T 7/70; G06V 10/761; G06T 2207/10016; G06V 2201/10

(57) ABSTRACT

In various examples, techniques for video metadata generation using video segmentation and data fusion are described herein. For instance, systems and methods described herein may segment a video may into video segments using one or more factors that are configured to enhance the processing of the individual video segments. For example, the video segments may be processed—such as by using one or more processing components and/or parallel processing—to generate instances of metadata associated with the video segments. As described herein, an instance of metadata may represent at least identifiers, spatio-temporal information, and/or visual information associated with objects as represented by a video segment. The systems and methods described herein may then analyze the instances of metadata to track objects between the video segments (e.g., perform object reassociation) and generate fused metadata associated with the video.

### CROSS-REFERENCE TO RELATED APPLICATIONS

This application is claims benefit of U.S. Provisional Application No. 63/772,141, filed Mar. 14, 2025, which is hereby incorporated by reference in its entirety.

### BACKGROUND

Efficient and effective object tracking is a critical task in video analytics applications, such as video surveillance, activity recognition, vehicle navigation, machine learning analysis, and/or the like. To perform video analytics, systems may utilize one or more object detection models to detect objects represented in images of a video. The systems may then estimate information associated with the detected objects, such as spatio-temporal information (e.g., locations, bounding shapes, velocities, accelerations, directions of travel, orientations, etc.) and/or visual information (e.g., colors, apparel, logos, etc.). Additionally, the systems may then use the information to track the objects through the videos and generate metadata associated with the tracks. For instance, the metadata for the objects may represent at least identifiers associated with the objects, the spatio-temporal information as determined over periods of time, and/or the visual information.

In some instances, these systems may require large amounts of computing resources and/or time to perform video analytics. For example, if a video being analyzed is substantial in duration—such as twelve hours or longer in length—analyzing the video may take hours and/or days to complete. Additionally, when analyzing long videos, the systems may be prone to error by unintentionally discontinuing tracks associated with some objects as the objects are moving throughout an environment. For example, the systems may lose the tracks of objects when the objects become occluded—such as by other objects—and/or the motion of the objects is inconsistent. When these problems occur while tracking the objects, the systems may further generate metadata for a video that associates the same object with different instances of information, which may cause problems for other systems that use the metadata to perform additional tasks.

### SUMMARY

Embodiments of the present disclosure relate to video metadata generation using video chunking and data fusion. For instance, systems and methods described herein may divide a video into individually playable video segments or “chunks” using one or more factors that are configured to enhance the processing of the individual video segments. For example, the video segments may be processed—such as by using one or more processing components and/or parallel processing—to generate instances of metadata associated with the video segments. As described herein, an instance of metadata may represent at least identifiers, spatio-temporal information, and/or visual information associated with objects as represented by a video segment. The systems and methods described herein may then analyze the instances of metadata to track objects between the video segments (e.g., perform object reassociation) and generate fused metadata associated with the video. As described herein, in some examples, the instances of metadata may be analyzed to generate the fused metadata using various techniques, such as subsequently with respect to one another and/or in groups.

In contrast to conventional systems, the systems of the present disclosure, in some embodiments, generate the metadata associated with a video using video segmentation and/or data fusion processing. As such, the systems of the present disclosure may reduce the amount of computing resources and/or time that is required to process videos as compared to the conventional systems that process entire videos when generating metadata. Additionally, and as described in more detail herein, processing segments of the video to generate the instances of metadata that are then fused may improve the accuracy of tracking objects throughout the video such that the fused metadata represents accurate information. For instance, and as described above, the conventional systems may be prone to error when tracking objects over long periods of time—such as based on objects being occluded and/or having inconsistent motion—where processing segments of videos removes these errors by detecting individual instances of objects in various video segments and then performing object reassociation between the video segments to continuously track the objects.

### BRIEF DESCRIPTION OF THE DRAWINGS

The present systems and methods for video metadata generation using video chunking and data fusion are described in detail below with reference to the attached drawing figures, wherein:

FIG. 1 illustrates an example data flow diagram for a process for generating metadata using video segmentation and data fusion, in accordance with some embodiments of the present disclosure;

FIG. 2 illustrates an example of segmenting a video into video segments, in accordance with some embodiments of the present disclosure;

FIG. 3 illustrates an example of generating instances of metadata associated with video segments, in accordance with some embodiments of the present disclosure;

FIGS. 4A-4B illustrate an example of sequentially fusing instances of metadata to generate fused metadata, in accordance with some embodiments of the present disclosure;

FIG. 5 illustrates an example of using groups to fuse instances of metadata to generate fused metadata, in accordance with some embodiments of the present disclosure;

FIGS. 6A-6B illustrate an example of fusing instances of metadata associated with multiple video segments, in accordance with some embodiments of the present disclosure;

FIGS. 7A-7B illustrate examples of performing spatio-temporal matching to determine whether tracklets correspond to a same object, in accordance with some embodiments of the present disclosure;

FIGS. 8A-8B illustrate an example of fusing tracks associated with an object over a number of video segments, in accordance with some embodiments of the present disclosure;

FIG. 9 illustrates an example of one or more systems that are configured to perform at least a portion of the processing described herein to generate fused metadata, in accordance with some embodiments of the present disclosure;

FIG. 10 illustrates a flow diagram showing a method for generating video metadata using video segmentation and data fusion, in accordance with some embodiments of the present disclosure;

FIG. 11 illustrates a flow diagram showing a method for fusing instances of metadata associated with different video segments of a video, in accordance with some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Systems and methods are disclosed for video metadata generation using video chunking and data fusion. For instance, a system(s) may receive, obtain, generate, and/or retrieve image data representing a video captured using one or more images sensors (e.g., one or more cameras). As described herein, the video may represent an environment—such as an interior environment and/or an exterior environment—over a period of time. For instance, the video may represent various objects—such as people, animals, vehicles, machines, robots, and/or the like—moving throughout the environment. The system(s) may then process the image data to generate metadata associated with the video. As described herein, the metadata may represent at least identifiers, spatio-temporal information (e.g., locations, bounding shapes, velocities, accelerations, directions of travel, orientations, etc.), and/or visual information (e.g., colors, apparel, logos, etc.) associated with the objects.

In some examples, the system(s) may perform one or more optimization techniques to reduce the amount of time it takes to process the image data and/or improve the quality of the metadata. For instance, the system(s) may segment the video into video segments that represent various portions, chunks, and/or the like associated with the video. For example, the video may be segmented into a first video segment, followed by a subsequent second video segment, followed by a subsequent third video segment, and/or so forth. In some examples, the system(s) may use one or more factors to perform the segmentation, such as a number of processing components that are used to process the video, one or more types of the processing components, a desired latency associated with performing the processing, a prespecified number, and/or any other factor. Additionally, in some examples, one or more of the video segments may at least partially overlap with one or more of the other video segments. For example, the second video segment in the example above may include a portion that overlaps with the first video segment (e.g., 15 images) and/or a portion that overlaps with the third video segment (e.g., 15 images).

The system(s) may then use the processing component(s) to process the video segments to generate instances of metadata associated with the video segments. As described herein, a processing component may include, but is not limited to, a machine learning model, a neural network, a classifier, a module, a processor, an application, an algorithm, an engine, and/or any other type of processing component. For example, a processing component may include an object detection model that at least detects objects represented by images of the video and/or an object tracking model that at least tracks the objects across the images of the video. In some examples, an individual processing component may be configured to process a respective video segment. Additionally, or alternatively, in some examples, an individual processing component may be configured to process multiple video segments.

The system(s) may then analyze the instances of metadata to generate fused metadata associated with the video. As described herein, in some examples, the system(s) may analyze the instances of metadata in subsequent order. For example, if the video includes three video segments, the system(s) may analyze (1) first metadata associated with the first video segment with respect to second metadata associated with the second video segment to generate first fused metadata and then (2) analyze the first fused metadata with respect to third metadata associated with the third video segment to generate second fused metadata associated with the video. Additionally, or alternatively, in some examples, the system(s) may group the instances of metadata for performing the analysis in different processing stages. For example, if the video includes four video segments, the system(s) may: (1) analyze a first group that includes first metadata associated with the first video segment and second metadata associated with the second video segment to generate first fused metadata associated with the first group, (2) analyze a second group that includes third metadata associated with the third video segment and fourth metadata associated with the fourth video segment to generate second fused metadata associated with the second group, and then (3) analyze the first fused metadata with respect to the second fused metadata to generate third fused metadata associated with the video.

To fuse instances of metadata, the system(s) may use at least the instances of metadata to detect one or more objects that are tracked between video segments and then fuse the information associated with the detected object(s). For example, first metadata associated with a first video segment may represent at least a first identifier, first spatio-temporal information, and first visual information associated with a first object while second metadata associated with a second video segment may represent at least a second identifier, second spatio-temporal information, and/or second visual information associated with a second object. The system(s) may then use the first metadata and the second metadata to determine that the first object from the first video segment is the same object as the second object from the second video segment. For example, and as described in more detail herein, the system(s) may determine a first similarity between the first spatio-temporal information and the second spatio-temporal information (e.g., after performing one or more projections) and/or a second similarity between the first visual information and the second visual information. The system(s) may then use the first similarity and/or the second similarity to determine that the second object includes the first object.

If the system(s) determines that multiple video segments represent the same object, then the system(s) may further fuse the information associated with the object when generating the fused metadata for the video segments. For example, and again using the example above, the system(s) may generate a fused identifier using the first identifier and/or the second identifier, fused spatio-temporal information using the first spatio-temporal information and the second spatio-temporal information, and/or fused visual information using the first visual information and the second visual information. The system(s) may then continue to perform these processes with regard to one or more additional objects (e.g., each of the objects) represented by the video segments when generating the fused metadata. As such, by performing such processes, even though instances of metadata may initially include different information for the same objects, the fused metadata may include the fused information such that the objects may be tracked throughout the video segments.

While these examples describe generating the fused metadata between video segments (e.g., perform inter segment fusion), in some examples, the system(s) may perform one or more similar processes to fuse information within an instance of metadata associated with a single video segment (e.g., perform intra segment fusion). For example, metadata associated with a video segment may represent multiple identifiers, spatio-temporal information, and/or visual information associated with the same object, such as when the system(s) loses a track of the object during processing. As such, by performing one or more of the processes described herein, the system(s) may reassociate the track of the object across an entirety of the video segment and then fuse the information such that the metadata represents a single identifier, spatio-temporal information, and/or visual information associated with the object. By performing such processes, the system(s) may increase the accuracy of the fused metadata associated with the video by verifying that objects are associated with single tracks throughout the video.

The system(s) may then perform one or more operations using the fused metadata. For example, the system(s) may store the fused metadata in association with the video in one or more databases, provide the fused metadata to one or more other systems that perform one or more tasks associated with processing the video, and/or perform any other operation.

In some examples, the model(s) (e.g., diffusion model, machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

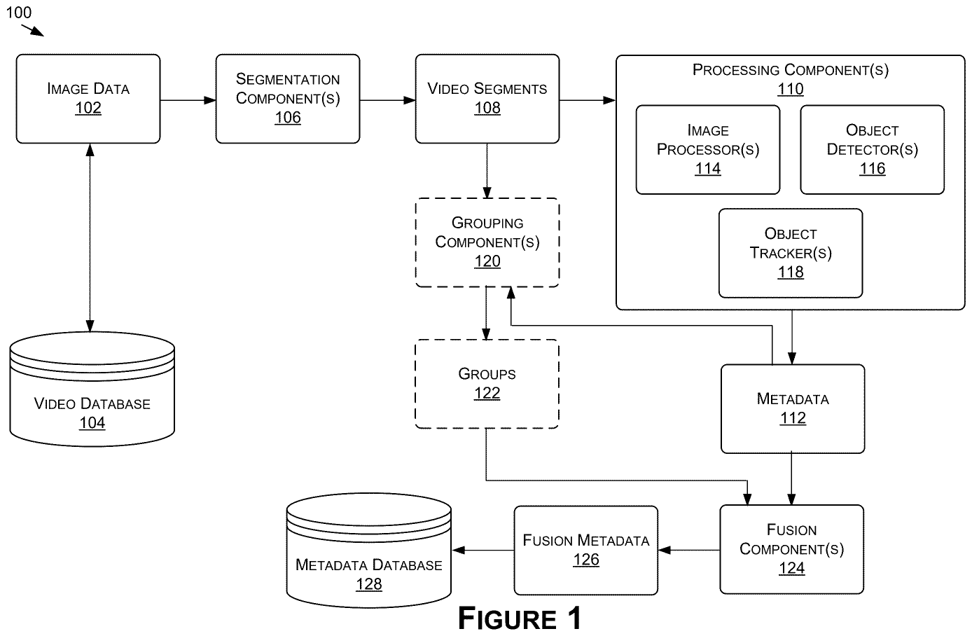

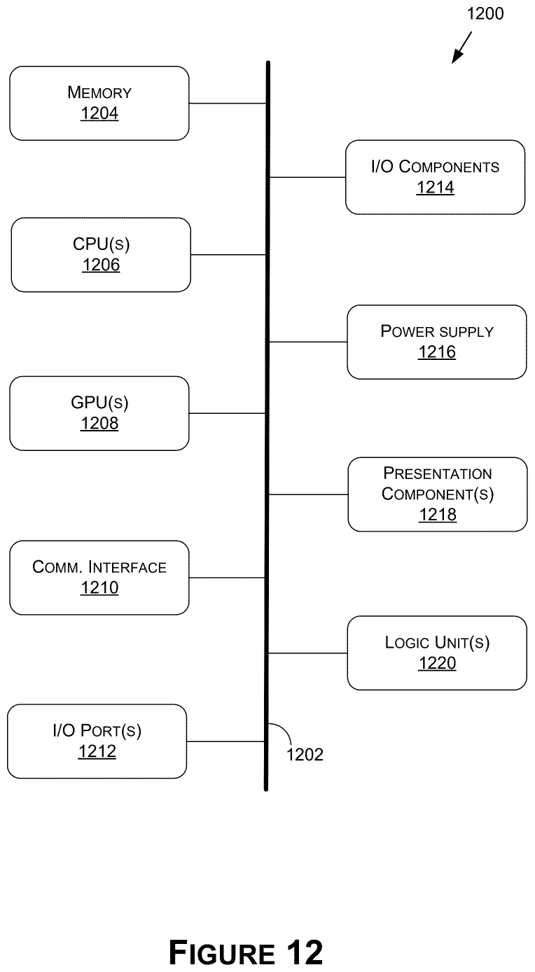

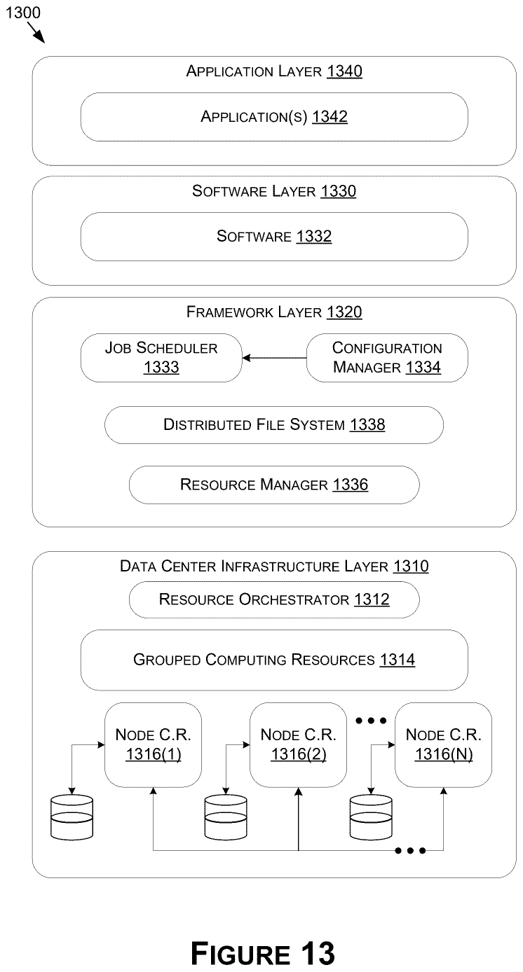

With reference to FIG. 1, FIG. 1 illustrates an example data flow diagram for a process 100 for generating metadata using video segmentation and data fusion, in accordance with some embodiments of the present disclosure. If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1200 of FIG. 12 and/or example data center 1280 of FIG. 13.

For instance, the process 100 may include receiving, obtaining, generating, and/or retrieving image data 102 representing a video captured using one or more images sensors (e.g., one or more cameras). For example, the image data 102 may be retrieved from an image database 104 that stores videos for processing using one or more of the processes described herein. As described herein, the video may represent an environment—such as an interior environment (e.g., a warehouse, factory, business, etc.) and/or an exterior environment—over a period of time. For instance, the video may represent various dynamic objects—such as people, animals, vehicles, machines, robots, and/or the like—and/or static object located within the environment over a period of time. In some examples, the image data 102 may be retrieved based on the occurrence of one or more events, such as receiving a request to generate metadata associated with the video.

The process 100 may include one or more segmentation components 106 processing the image data 102 to generate video segments 108 representing portions, chunks, and/or the like of the video for processing by one or more processing components 110. For example, the segmentation component(s) 106 may segment the video into a first video segment 108, followed by a subsequent second video segment 108, followed by a subsequent third video segment 108, and/or so forth. In some examples, the segmentation component(s) 106 may use one or more factors to perform the segmentation, such as a number of the processing component(s) 110 used to process the video, one or more types of the processing component(s) 110, a desired latency associated with performing the processing, a prespecified number, and/or any other factor. For example, the segmentation component(s) 106 may use the factor to determine a number of segments and/or one or more segment lengths for partitioning the video. The segmentation component(s) 106 may then use the number of segments and/or the video length(s) to generate the video segments 108.

Additionally, in some examples, one or more of the video segments 108 may at least partially overlap with one or more of the other video segments 108. For example, the second video segment 108 in the example above may include a portion that overlaps with the first video segment 108 (e.g., 15 images) and/or a portion that overlaps with the third video segment 108 (e.g., 15 images). However, in other examples, the video segments 108 may not overlap with one another. For example, the second video segment 108 in the example above may begin at or near the end of the first video segment 108, the third video segment 108 may begin at or near the end of the second video segment 108, and/or so forth.

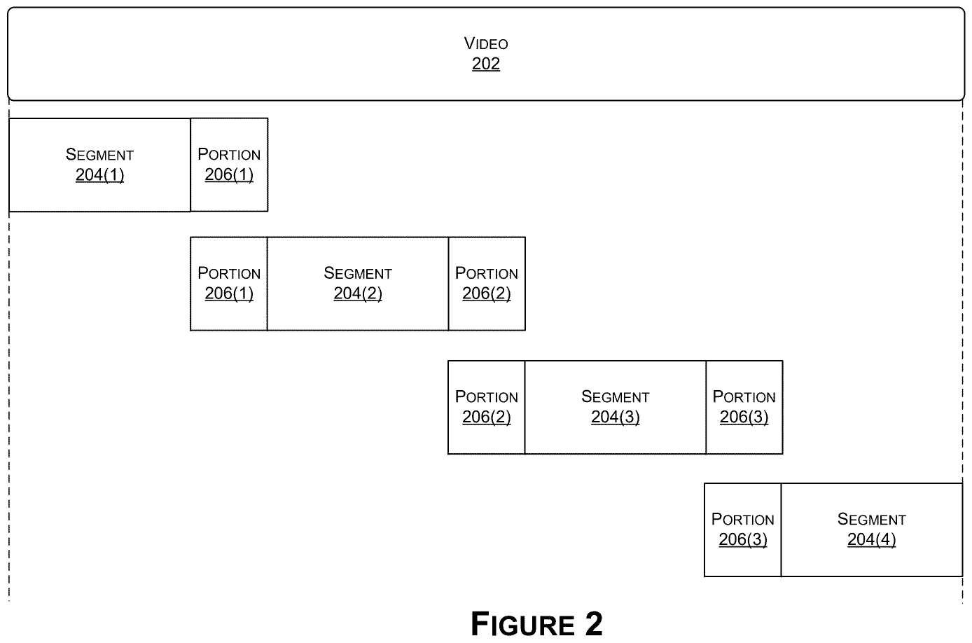

For more details, FIG. 2 illustrates an example of segmenting a video 202 into video segments 204(1)-(4) (also referred to singularly as “video segment 204” or in plural as “video segments 204”), in accordance with some embodiments of the present disclosure. In the example of FIG. 2, the segmentation component(s) 106 may segment the video 202 using one or more factors. For a first example, if the video 202 is to be processed using four processing components 110, then the segmentation component(s) 106 may segment the video 202 into the four video segments 204 for processing by the processing components 110, which is described in more detail herein. For a second example, if the video 202 is to be processed using three processing components 110, but one of the processing components 110 includes a type that is twice as fast as the other two processing components 110 when processing image data, the segmentation component(s) 106 may again segment the video 202 into the four video segments 204 such that the faster processing component 110 is then provided with two video segments 204 for processing.

As further shown by the example of FIG. 2, the segmentation component(s) 106 may segment the video 202 such that the video segments 204 includes overlapping portions 206(1)-(3) (also referred to singularly as “overlapping portion 206” or in plural as “overlapping portions 206”) with respect to one another. For example, the second video segment 204(2) shares the first overlapping portion 206(1) with the first video segment 204(1) and the second overlapping portion 206(2) with the third video segment 204(3). As described herein, in some examples, the overlapping portions 206 may be associated with a given number of images, such as 15 images (and/or any other number of images). Additionally, or alternatively, in some examples, the overlapping portions 206 may be associated with a given length of the video 202, such as 30 seconds (and/or any other length). As described in more detail herein, the segmentation component(s) 106 may generate the video segments 204 to include the overlapping portions 206 in order to improve the processing that is performed when tracking objects between the video segments 204.

While the example of FIG. 2 illustrates the video 202 being segmented into four video segments 204, in other examples, the segmentation component(s) 106 may segment the video 202 into any other number of video segments. Additionally, while the example of FIG. 2 illustrates the video segments 204 as including the overlapping portions 206, in other examples, the segmentation component(s) 106 may segment the video 202 into video segments that do not include any overlapping portions with respect to one another.

Referring back to the example of FIG. 1, the process 100 may include using the processing component(s) 110 to process the image data 102 representing the video segments 108 in order to generate instances of metadata 112 associated with the video segments 108. As described herein, a processing component 110 may include, but is not limited to, a machine learning model, a neural network, a classifier, a module, a processor (e.g., a graphic processing unit (GPU), a central processing unit (CPU), etc.), an application, an algorithm, an engine, and/or any other type of processing component that is configured to perform one or more of the processes described herein. For example, a processing component 110 may include a GPU that executes an object detection model that at least detects objects represented by images of the video and/or an object tracking model that at least tracks the objects across images of the video.

In some examples, such as based on the segmentation, an individual processing component 110 may be configured to process a single video segment 108. For example, a first processing component 110 may process a first video segment 108 to generate a first instance of metadata 112, a second processing component 110 may process a second video segment 108 to generate a second instance of metadata 112, and/or so forth. Additionally, or alternatively, in some examples, an individual processing component 110 may be configured to process multiple video segments 108. For example, a first processing component 110 may be configured to process a first group of video segments 108 to generate first instances of metadata 112, a second processing component 110 may be configured to process a second group of video segments 108 to generate second instances of metadata 112, and/or so forth.

For more details, a processing component 110 may include an image processor 114 that is configured to process the image data 102. For example, the image processor 114 may at least encode the image data 102 (e.g., using a codec), modify a quality of the image data 102 for object detection and/or object tracking, and/or perform any other type of processing on the image data 102. For example, the image processor 114 may be configured to apply one or more transformations to an image represented by the image data 102 to remove or reduce an amount of noise present in the image, to crop the image, and so on.

A processing component 110 may further include an object detector 116 configured to detect one or more objects included in images represented by the image data 102. In some examples, the object detector 116 may provide an image depicting an environment as input to a trained object detection model. The object detection model may be trained using historical data (e.g., historical images, historical object data, etc.) from one or more datasets to detect an object (referred to here as a detected object) included in a given input image depicting an environment and estimate a region of the given input image that includes the detected object (referred to herein as a region of interest). In some examples, one or more outputs of the object detection model may indicate object data associated with the detected object. The object data may indicate a region of interest of a given input image that includes the detected object. For example, the object data may include a bounding box or another bounding shape (e.g., a spheroid, an ellipsoid, a cylindrical shape, a polygon, etc.) that corresponds to the region of interest of the given input image. In some examples, the object data may include other data associated with the detected object, such as an object class corresponding to the detected object, mask data associated with the detected object (e.g., a two-dimensional (2D) bit array that indicates pixels (or groups of pixels) that corresponds to the detected object), visual information associated with the detected object, and so forth.

A processing component 110 may further include an object tracker 118 configured to track a state of one or more objects detected in one or more images. In some examples, an object that is tracked by the object tracker 116 may be referred to herein as a target object or a tracked object. A state of a target object, as provided herein, may correspond to a location of an object within an environment depicted by the one or more images, a position of the object within the environment, a velocity of the object within the environment, a visual appearance of the object, a set of visual features of the object, and so forth. For instance, in some examples, the object tracker 118 may include a motion tracking module and appearance tracking module to track motion aspects of the target and visual appearance aspects of the target, respectively.

In some embodiments, the object tracker 118 may track a target object based on an image including the target object and object data (e.g., one or more bounding boxes, visual appearance features of the object, etc.) associated with the target object. The object tracker 118 may instantiate an object tracker instance (referred to as a target instance and/or a tracklet herein) for each detected object in an image depicting the environment. A target instance may be a component such as a software object, a database entry, and/or the like that is configured to maintain state data associated with a target object within a set of images (e.g., a sequence of video images) depicting the environment. For example, when an object is initially detected in an image (e.g., a video image), the object tracker 118 may instantiate a target instance to monitor and determine a state associated with the detected object. The object detector 116 may then detect the target object in other images depicting the environment (e.g., subsequent video images) and the target instance associated with the target object may determine, for individual images (e.g., each of the other images), the current state of the target object. The target instance may update state data associated with the object to correspond to the determined current state and store the updated state data. In some examples, the target instance may further estimate a future state of the target object in the environment and may store an indication of the future state with the updated state data. The processing component 110 may then generate an instance of metadata 112 based at least on the outputs from the object detector 116 and/or the object tracker 118.

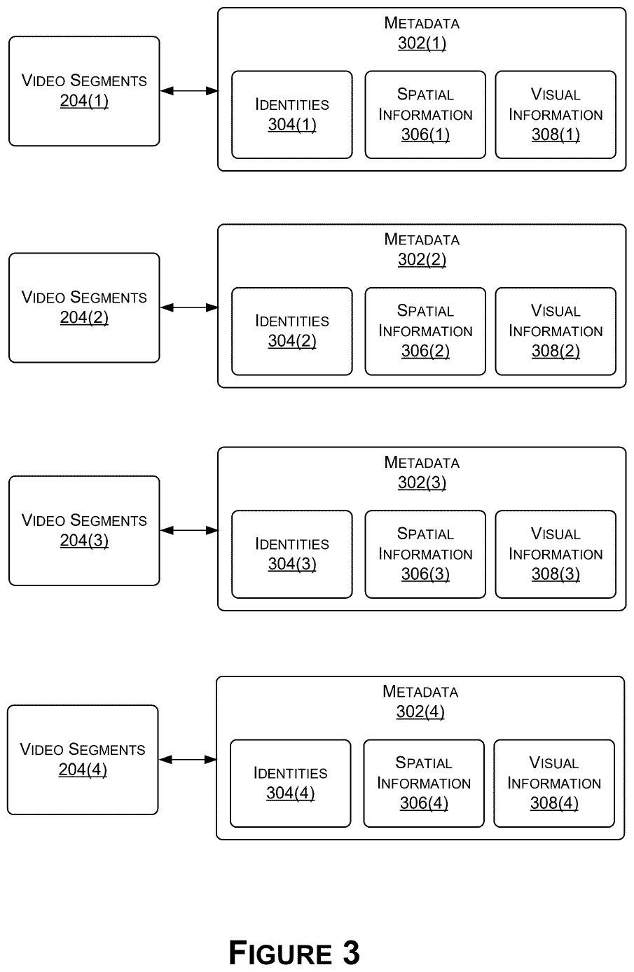

For instance, FIG. 3 illustrates an example of generating instances of metadata associated with video segments, in accordance with some embodiments of the present disclosure. As shown, the processing component(s) 110 may process the video segments 204 to respectively generate the instances of metadata 302(1)-(4) (also referred to as “metadata 302”). Additionally, the metadata 302 may include at least identifiers 304(1)-(4) (also referred to singularly as “identifier 304” or in plural as “identifiers 304”) associated with objects, spatial information 306(1)-(4) (also referred to as “spatial information 306”) associated with the objects, and visual information 308(1)-(4) (also referred to as “visual information 308”) associated with the objects. In some examples, a single processing component 110 may generate all of the metadata 302. However, in some examples, multiple processing components 110 may be used to generate the metadata 302. For example, each of the video segments 204 may be processed using a respective processing component 110 to generate the respective instance of metadata 302.

As described herein, an identifier 304 may include, but is not limited to, a numerical identifier, an alphabetic identifier, an alphanumeric identifier, a code, a name, and/or any other type of identifier that may be used to track an object. Additionally, spatial information 306 may represent spatio-temporal information associated with an object, such as a location (e.g., a two-dimensional (2D) location within an image, a three-dimensional (3D) location within the environment, etc.), a bounding shape, a velocity, an acceleration, a direction of travel, an orientation, and/or any other information associated with the location and/or motion of the object. Furthermore, visual information 308 associated with an object may include, but is not limited to, one or more colors, apparel, one or more logos, and/or any other visual description associated with the object. In some examples, the visual information 308 may be represented using one or more types of data structures, such as embeddings and/or vectors.

Referring back to the example of FIG. 1, in some examples, the process 100 may include using one or more grouping components 120 to group the video segments 108 (and/or the instances of metadata 112) into groups 122 for processing by one or more fusion components 124. As described herein, the grouping component(s) 120 may use one or more factors to group the video segments 108, such as a number of video segments 108, a number of the fusion component(s) 124 for fusing the instances of metadata 112, lengths of the video segments 108, sizes of the instances of metadata 112, and/or any other factor. For a first example, if multiple fusion components 124 are available to perform the fusion processing described herein, then the grouping component(s) 120 may group the video segments 108 equally and/or substantially equally among the fusion components 124. For a second example, the grouping component(s) 120 may group the video segments 108 when there are at least a threshold number of the video segments 108 to perform fusion processing.

The process 100 may then include using the fusion component(s) 124 to process the instances of metadata 112 and generate fused metadata 126 associated with the video, where the fused metadata 112 is then stored in a metadata database 128. As described herein, the fusion component(s) 124 may use one or more techniques to process the instances of metadata. For a first example, the fusion component(s) 124 may fuse the instances of metadata 112 in a sequential pattern, such as by starting with the instance of metadata 112 associated with the first video segment 108 and proceeding through to the instance of metadata 112 associated with the last video segment 108. For a second example, the fusion component(s) 124 may fuse the instances of metadata 112 according to the groups 122 and in multiple processing stages. In some examples, a single fusion component 124 may be used to fuse all of the instances of metadata 112. However, in other examples, multiple fusion components 124 may be used to fuse the instances of metadata 112. For example, and if the video segments 108 are grouped, then a respective fusion component 124 may process the instances of the metadata 112 associated with each group 122.

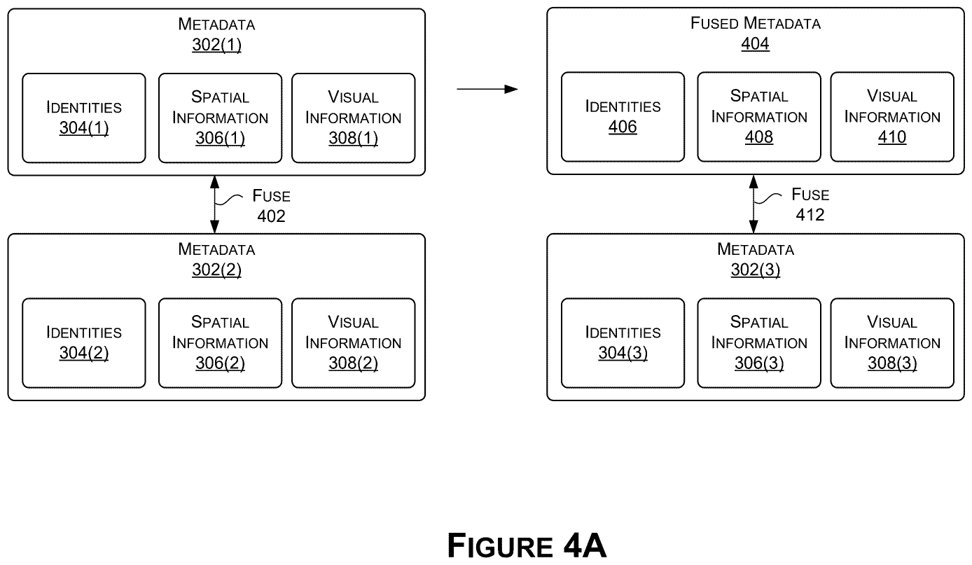

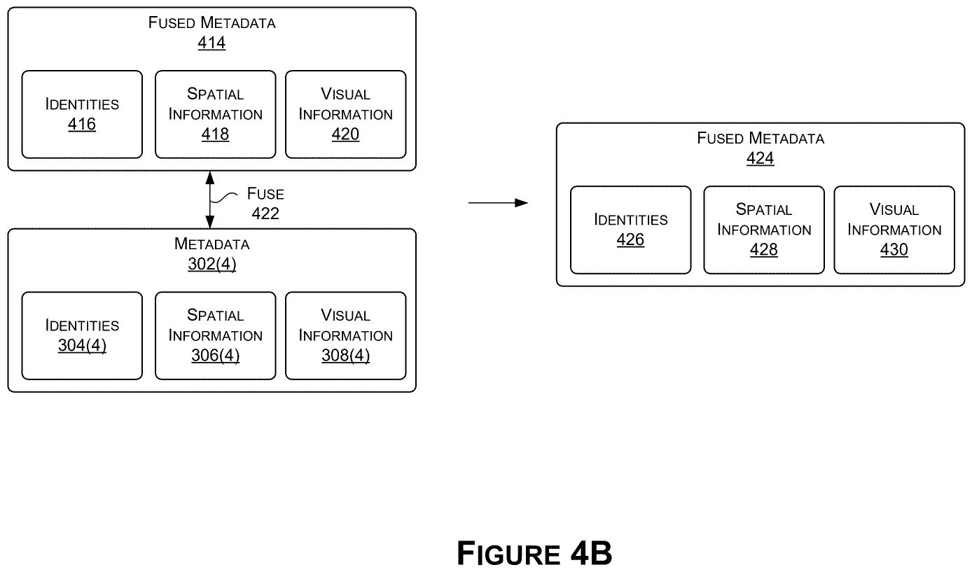

For more details, FIGS. 4A-4B illustrate an example of sequentially fusing instances of metadata 302 to generate fused metadata, in accordance with some embodiments of the present disclosure. As shown, during a first processing stage, the fusion component(s) 124 may perform one or more of the processes described herein to fuse 402 the first instance of metadata 302(1) associated with the first video segment 204(1) with the second instance of metadata 302(2) associated with the second video segment 204(2) to generate first fused metadata 404 associated with the video segments 204(1)-(2). As shown, the first fused metadata 404 may represent at least identifiers 406 associated with objects, spatial information 408 associated with the objects, and visual information 410 associated with the objects represented by the video segments 204(1)-(2).

During a second processing stage, the fusion component(s) 124 may then fuse 412 the first fused metadata 404 with the third instance of metadata 302(3) associated with the third video segment 204(3) to generate second fused metadata 414 associated with the video segments 204(1)-(3). As shown, the second fused metadata 414 may represent at least identifiers 416 associated with objects, spatial information 418 associated with the objects, and visual information 420 associated with the objects represented by the video segments 204(1)-(3). Finally, during a third processing stage, the fusion component(s) 124 may fuse 422 the second fused metadata 414 with the fourth instance of metadata 302(4) associated with the fourth video segment 204(4) to generate third fused metadata 424 associated with the video 202. As shown, the third fused metadata 424 may represent at least identifiers 426 associated with objects, spatial information 428 associated with the objects, and visual information 430 associated with the objects represented by the video 202.

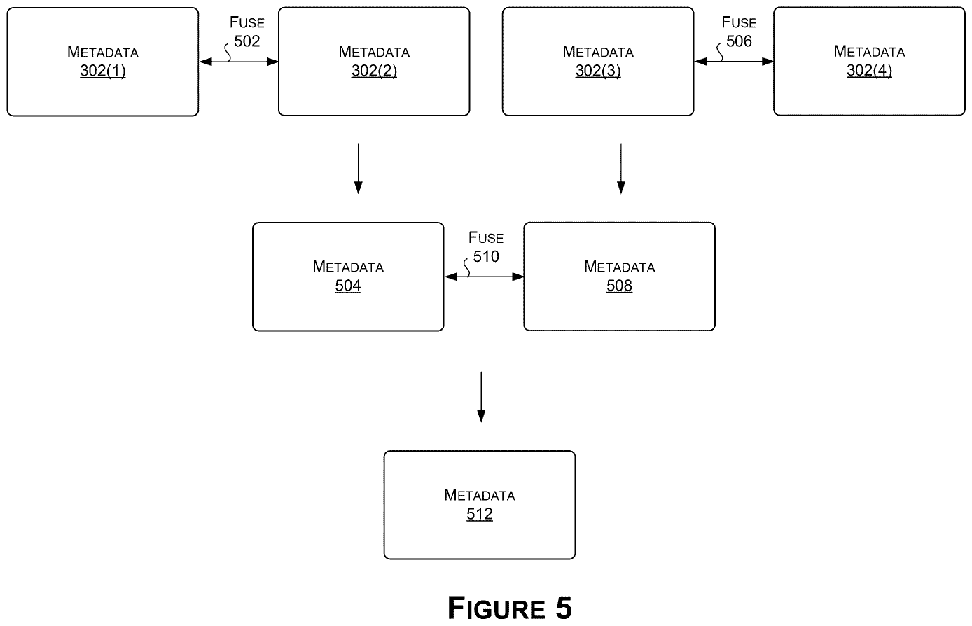

Next, FIG. 5 illustrates an example of using groups to fuse instances of metadata to generate fused metadata, in accordance with some embodiments of the present disclosure. As shown, the grouping component(s) 120 may have initially grouped the video segments 204(1)-(2) into a first group and the video segments 204(3)-(4) into a second group. As such, during a first processing stage, the fusion component(s) 124 may fuse 502 the first instance of metadata 302(1) with the second instance of metadata 302(2) to generate first fused metadata 504 associated with the video segments 204(1)-(2) and fuse 506 the third instance of metadata 302(3) with the fourth instance of metadata 302(4) to generate second fused metadata 508 associated with the video segments 204(3)-(4). Next, during a second processing stage, the fusion component(s) 124 may fuse 510 the first fused metadata 504 with the second fused metadata 508 to generate third fused metadata 512 associated with the video 202.

In some examples, during the first processing stage, a first fusion component 124 may be configured to fuse 502 the instances of metadata 302(1)-(2) to generate the first fused metadata 504 and a second, different fusion component 124 may be configured to fuse 506 the instances of metadata 302(3)-(4) to generate the second fused metadata 508. Additionally, in such examples, the first fusion component 124 and/or the second fusion component 124 may fuse 510 the first fused metadata 504 with the second fused metadata 508 to generate the third fused metadata 512. By performing such processes, the entire fusion processes may be performed in two processing stages, which may reduce the latency associated with generating the metadata associated with the video 202.

Referring back to the example of FIG. 1, the fusion component(s) 124 may perform any type of processing to perform one or more of the processes described herein. For instance, the fusion component(s) 124 may use at least the instances of metadata 112 to track one or more objects between video segments 108 and then fuse the information associated with the objects. For example, a first instance of metadata 112 associated with a first video segment 108 may represent at least a first identifier, first spatio-temporal information, and first visual information associated with a first object while a second instance of metadata 112 associated with a second video segment 108 may represent at least a second identifier, second spatio-temporal information, and/or second visual information associated with a second object. The fusion component(s) 124 may then use the first instance of metadata 112 and the second instance of metadata 112 to determine that the first object from the first video segment 108 is the same object as the second object from the second video segment 108. For example, and as described in more detail herein, the fusion component(s) 124 may determine a first similarity between the first spatio-temporal information and the second spatio-temporal information (e.g., after performing one or more projections) and/or a second similarity between the first visual information and the second visual information. The fusion component(s) 124 may then use the first similarity and/or the second similarity to determine that the second object includes the first object.

If the fusion component(s) 124 determines that multiple video segments 108 represent the same object, then the fusion component(s) 124 may further fuse the information associated with the object when generating the fused metadata 126 for the video segments 108. For example, and again using the example above, the fusion component(s) 124 may generate a fused identifier using the first identifier and/or the second identifier, fused spatio-temporal information using the first spatio-temporal information and the second spatio-temporal information, and/or fused visual information using the first visual information and the second visual information. The fusion component(s) 124 may then continue to perform these processes with regard to one or more additional objects (e.g., each of the objects) represented by the video segments 108 when generating the fused metadata 126. As such, by performing such processes, even though instances of metadata 112 may initially include different information for the same objects, the fused metadata 126 may include the fused information such that the objects may be tracked between the video segments 108.

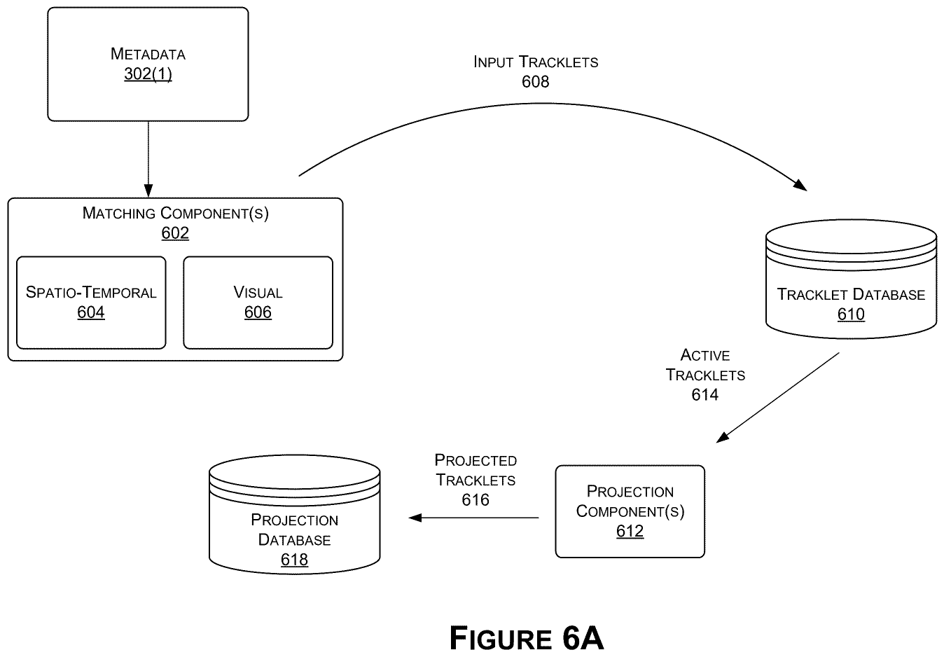

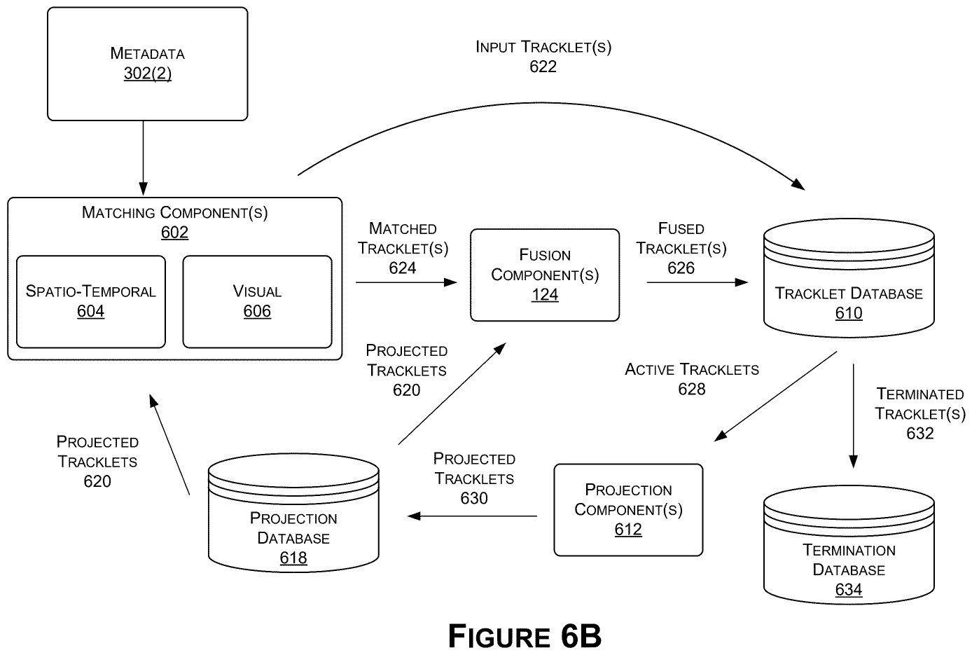

For more details, FIGS. 6A-6B illustrate an example of fusing instances of metadata associated with multiple video segments, in accordance with some embodiments of the present disclosure. As shown by the example of FIG. 6A, one or more matching components 602 may receive the first instance of metadata 302(1) associated with the first video segment 204(1). The matching component(s) 602 may then perform one or more matching techniques—such as a spatio-temporal matching technique 604 and/or a visual matching technique 606—to determine whether objects represented by the first instance of metadata 302(1) match active tracks. However, since this is the first instance of metadata 302(1), the matching component(s) 602 may determine that there are no matches associated with the objects (e.g., there are no active tracks).

The matching component(s) 602 may then input tracklets 608 (e.g., detected tracks) associated with the objects to a tracklet database 610 that maintains active tracklets associated with the objects. As described herein, a tracklet may be a data object comprising information related to a current and/or future state associated with an object. For example, a tracklet may include a set of coordinates or a set of bounding shapes associated with the location of the object over several images. In some examples, a tracklet may further include speeds, velocities, trajectories, or sets thereof indicating a path taken by the object over a series of images.

Next, one or more projection components 612 may receive, from the tracklet database 610, active tracklets 614 that are associated with objects currently being tracked. The projection component(s) 612 may predict future motion characteristics of a tracked object based on past and current motion characteristics, such as motion data maintained in the target tracklet data. The projection component(s) 612 may use one or more state estimators alone or in combination to predict future positions, trajectories, search locations, or other motion characteristics of the target. For a first example, Kalman filters with various filter parameters may be used for various motion trends (e.g., short-, medium-, and long-term trends) and in various environments. For a second example, a neural network may be used as a predictor. Motion predictions of the projection component(s) 612 may further comprise estimates of error or uncertainty associated with the state data associated with the tracklets. As shown, the projection component(s) 612 may then provide projected tracklets 616 to a projection database 618.

Next, as shown by the example of FIG. 6B, the matching component(s) 602 may receive the second instance of metadata 302(2) associated with the second video segment 204(2), where the second instance of metadata 302(2) is to be fused with the first instance of metadata 302(1). Additionally, the matching component(s) 602 may also receive projected tracklets 620 that are stored in the projection database 618. The matching component(s) 602 may then determine whether the objects represented by the second instance of metadata 302(2) match the objects associated with the projected tracklets 620. As described herein, the matching component(s) 602 may use one or more techniques to perform the matching, such as the spatio-temporal matching 604 and/or the visual matching 606.

For instance, in some examples, the matching component(s) 602 may perform spatio-temporal matching 604 to compare the tracklets associated with the objects as represented by the second instance of metadata 302(2) to the projected tracklets 620 to determine whether the tracklets correspond to the same object. In some examples, the comparison may include performing similarity calculations between the tracklets, such as a calculation that measures similarities between bounding shapes associated with the tracklets (e.g., determining amounts of overlap between the bounding shapes), a calculation that measures similarities between trajectories associated with the tracklets, and/or any other similarity calculations. The spatio-temporal matching 604 may then compare the similarity scores to one or more correlation thresholds to determine whether the tracklets correspond to the same object or different objects. For instance, the spatio-temporal matching 604 may determine that the tracklets correspond to the same object when a similarity score satisfies (e.g., is equal to or greater than) a threshold score or determine that the tracklets do not correspond to different objects when the similarity score does not satisfy (e.g., is less than) the threshold score.

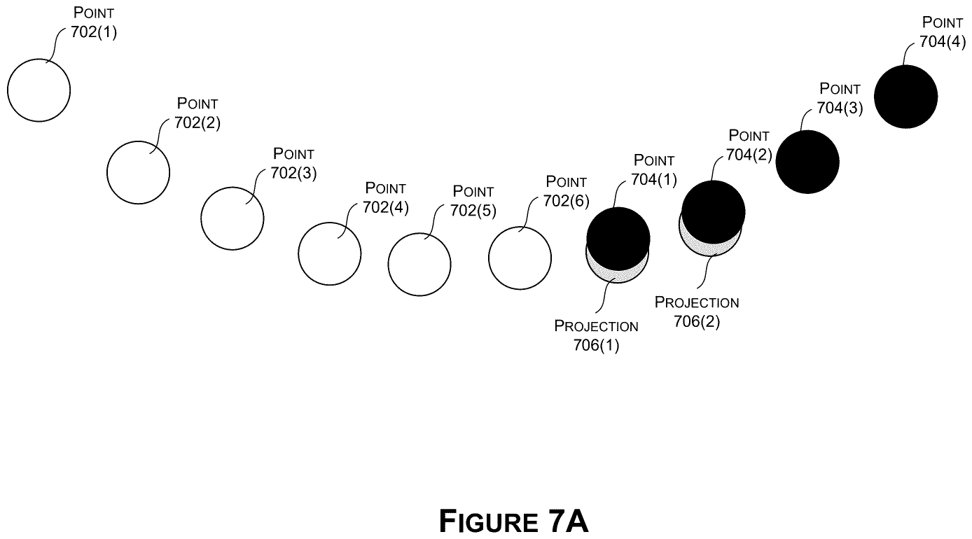

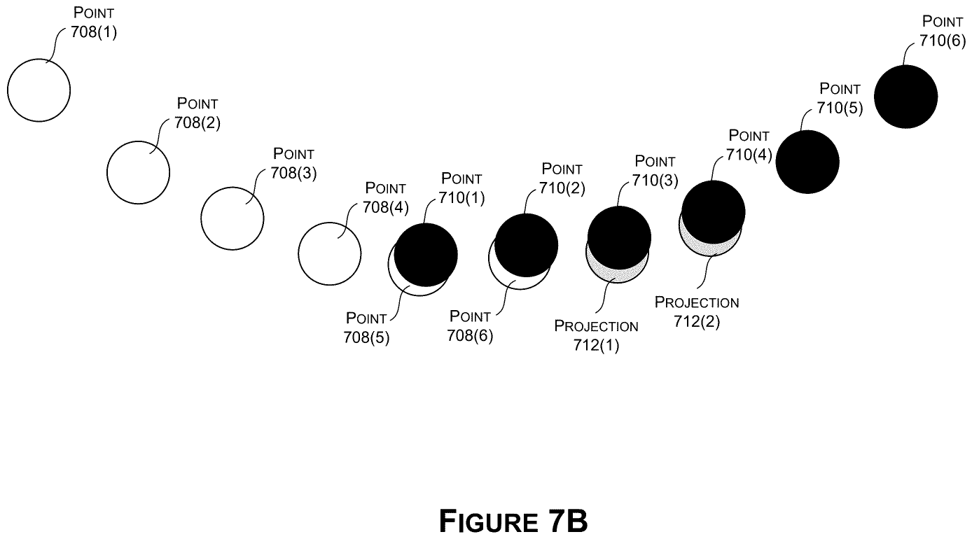

For more details, FIGS. 7A-7B illustrate examples of performing spatio-temporal matching to determine whether tracklets correspond to a same object, in accordance with some embodiments of the present disclosure. As shown, FIG. 7A may correspond to an example when the video segments do not overlap with one another. As such, a first object from a first video segment may be associated with a first tracklet that includes first points 702(1)-(6) and a second object from a second video segment may be associated with a second tracklet that includes second points 704(1)-(4). Additionally, using at least the first points 702(1)-(6), the projection component(s) 612 may determine projected points 706(1)-(2) associated with the first tracklet. The matching component(s) 602 may then perform spatio-temporal matching 604 to determine a similarity score between the tracklets based at least on comparing the first points 702(1)-(6) and/or the projected points 706(1)-(2) to the second points 704(1)-(4). Additionally, in the example of FIG. 7A, the matching component(s) 602 may determine that the tracklets correspond to the same object based at least on the similarity score (e.g., the similarity score satisfies a threshold score).

Next, FIG. 7B may correspond to an example when the video segments do overlap with one another (e.g., the video segments 204(1)-(2)). As such, a first object from a first video segment may be associated with a first tracklet that includes first points 708(1)-(6) and a second object from a second video segment may be associated with a second tracklet that includes second points 710(1)-(6), where the tracklets at least partially overlap. Additionally, using at least the first points 708(1)-(6), the projection component(s) 612 may determine projected points 712(1)-(2) associated with the first tracklet. The matching component(s) 602 may then perform spatio-temporal matching 604 to determine a similarity score between the tracklets based at least on comparing the first points 708(1)-(6) and/or the projected points 712(1)-(2) to the second points 710(1)-(6). Additionally, in the example of FIG. 7B, the matching component(s) 602 may determine that the tracklets correspond to the same object based at least on the similarity score (e.g., the similarity score satisfies a threshold score).

In some examples, by segmenting the video into the video segments that include overlapping portions, the matching component(s) 602 may better determine whether tracklets correspond to the same object since more of the tracklets that overlap with respect to one another and/or the points of the overlapped portions of the tracklets include more accurate measurements. For instance, and as shown in the example of FIG. 7B, the overlapping portions of the tracklets include the first points 708(5)-(6) and the second points 710(1)-(2) that are measured from actual data rather than projected.

Referring back to the example of FIG. 6B, in some examples, the matching component(s) 602 may use perform visual matching 606 to determine whether tracklets correspond to the same objects. For instance, the visual matching 606 may compare two or more visual appearance descriptors to determine whether the descriptors correspond to the same object or to different objects. The comparison performed by the visual matching 606 may differ in various examples based on the type of visual appearance descriptor used. In at least one example, where visual appearance descriptors are vectors in an embedded vector space, visual matching 606 may compare descriptors by calculating distances between the corresponding vectors to generate similarity metrics and comparing the metrics to one or more threshold values. Examples of distance calculations may include cosine similarity, dot product, L1 norm (e.g., Manhattan distance), L2 norm (e.g., Euclidean distance), and/or any other type of distance calculations. The visual matching 606 may determine that the compared vectors correspond to the same object if the distance metric is less than a threshold in some examples and greater than a threshold in other examples, where the threshold values may be global or local values. For example, the visual matching 606 may use the same threshold values for every vector comparison or may use different threshold values for different comparisons. In at least one example, where visual appearance descriptors are images (e.g., identity transformations of features identified by bounding boxes), the visual matching 606 may compare descriptors by calculating a cross-correlation or convolution of the images (or other similarity measure) and generating a similarity metric using the peak value.

In some examples, the matching component(s) 602 may use both the spatio-temporal matching 604 and the visual matching 606 to determine whether tracklets correspond to the same object. For instance, the matching component(s) 602 may use similarity metrics and/or similarity scores from the spatio-temporal matching 604 and the visual matching 606 and combine the data to generate a merged similarity metric or determination. In at least one example, the matching component(s) 602 may use a continuous or discrete decision boundary to determine whether two targets match, which may be generated using a machine learning model, tuned by a user using one or more parameters, or generated in other ways. In at least one example, similarity metrics from constituent tracking modules may be multiplied by a weight associated with module importance, and the weighted metrics may be added, multiplied, or otherwise combined to generate a single merged similarity metric. The merged similarity metric may be compared to a threshold value (e.g., user- or system-determined) to determine whether the targets match. In at least one example, the matching component(s) 602 may facilitate a voting system, where similarity determinations of various tracking modules may be voted against each other to determine a majority decision (or plurality, supermajority, etc.) for matching targets. Different tracking modules may have different numbers of votes or different weights applied to votes. Other ways of combining tracking module similarity information may be used in various examples.

As further shown by the example of FIG. 6B, the matching component(s) 602 may input one or more tracklets 622 associated with one or more objects for which there was no match to the tracklet database 610 (e.g., one or more new objects). Additionally, the fusion component(s) 124 may receive an indication of one or more matched tracklets 624 from the matching component(s) 602 along with the projected tracklets 620 from the projection database 618 and perform fusion associated with the matched tracklet(s) 624. In at least one example, the fusion component(s) 124 may move or copy current motion data of a current tracklet corresponding to an object to a previous tracklet corresponding to the object. The fusion component(s) 124 may further interpolate motion data between the previously-current motion data and the now-current motion data to fill in the occluded motion. In another example, the fusion component(s) 124 may use a machine learning algorithm to generate the interpolation. In at least one example, the fusion component(s) 124 may move or copy visual appearance descriptors of the second instance of the metadata 302(2) to visual appearance descriptors of first instance of the metadata 302(1). The fusion component(s) 124 may further remove unneeded or unnecessarily duplicative identifiers and/or may trigger generation of a new identifier at the time of reassociation. The fusion component(s) 124 may then input one or more fused tracklets 626 into the tracklet database 610.

As further illustrated in the example of FIG. 6B, the projection component(s) 612 may receive, from the tracklet database 610, active tracklets 628 that are associated with objects currently being tracked. The projection component(s) 612 may then predict future motion characteristics of a tracked object based on past and current motion characteristics, such as motion data maintained in the target tracklet data. The projection component(s) 612 may use one or more state estimators alone or in combination to predict future positions, trajectories, search locations, or other motion characteristics of the target. For a first example, Kalman filters with various filter parameters may be used for various motion trends (e.g., short-, medium-, and long-term trends) and in various environments. For a second example, a neural network may be used as a predictor. Motion predictions of the projection component(s) 612 may further comprise estimates of error or uncertainty associated with the state data associated with the tracklets. As shown, the projection component(s) 612 may then provide projected tracklets 630 to the projection database 618.

In some examples, the tracklet database 610 may further provide one or more terminated tracklets 632 to a termination database 634. As described herein, a tracklet may be terminated based at least on the object not being detected for a threshold period of time and/or for a threshold number of images. For instance, the track associated with the object may be terminated based at least on the object no longer being detected such that the object is no longer in the environment being monitored. In some examples, these processes may then continue to repeat as new instances of metadata 302 are processed for performing fusion.

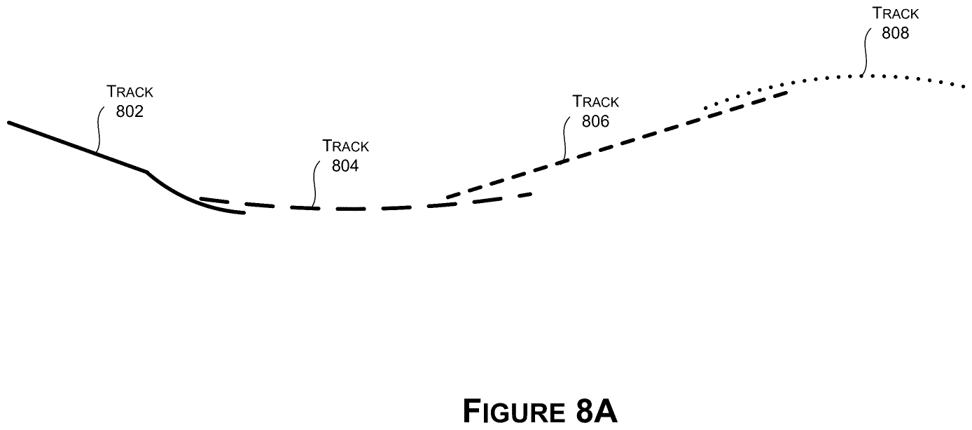

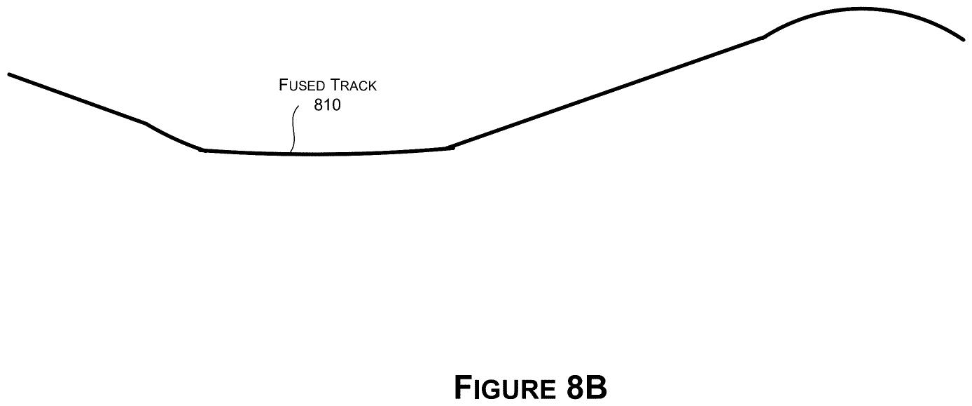

For an example of the results of fusion, FIGS. 8A-8B illustrate an example of fusing tracks associated with an object over a number of video segments, in accordance with some embodiments of the present disclosure. As shown by the example of FIG. 8A, by performing one or more of the processes described herein, the first instance of metadata 302(1) may represent at least a first identifier and a first track 802 for a first object, the second instance of metadata 302(2) may represent at least a second identifier and a second track 804 for a second object, the third instance of metadata 302(3) may represent at least a third identifier and a third track 806 for a third object, and the fourth instance of metadata 302(4) may represent at least a fourth identifier and a fourth track 808 for a fourth object. As such, the matching component(s) 602 may perform one or more of the processes described herein to determine that the objects represented by each of the instances of metadata 302 include the same object.

As such, and as shown by the example of FIG. 8B, the fusion component(s) 124 may perform one or more of the processes described herein to fuse the tracks 802, 804, 806, and 808 for the object and create a single track 810. Additionally, the fusion component(s) 124 may use one of the identifiers for the object as represented by the instances of metadata 302 to determine a final identifier to associate with the object. As such, by performing such processes, fused metadata may represent a single identifier and single track 810 associated with the object.

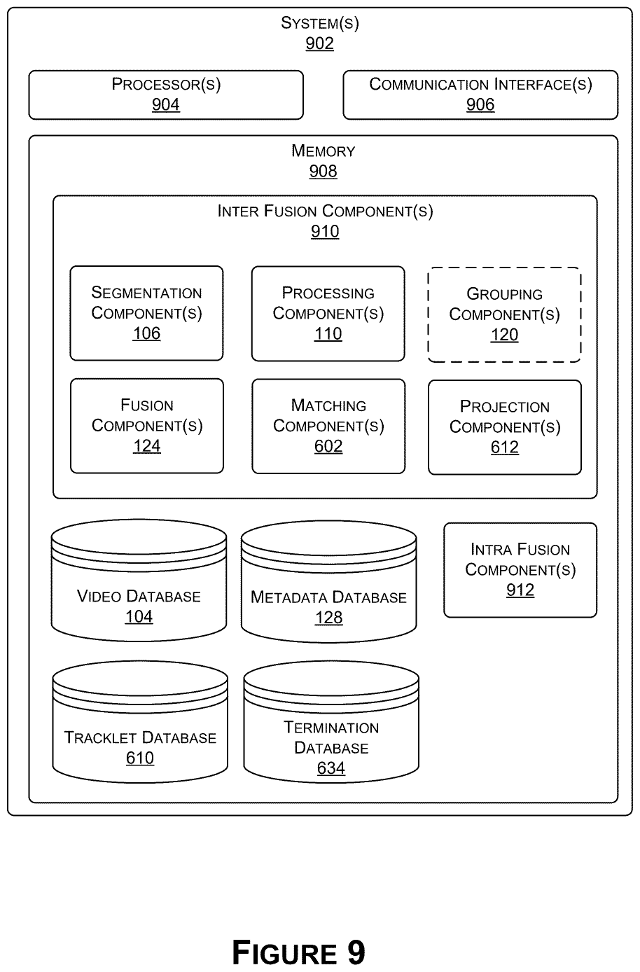

FIG. 9 illustrates an example of one or more systems 902 that are configured to perform at least a portion of the processing described herein to generate fused metadata, in accordance with some embodiments of the present disclosure. As shown, the system(s) 902 may include one or more processors 904 (which may include, and/or be similar to, a CPU(s) 1206 and/or a GPU(s) 1208), one or more communication interfaces 906 (which may include, and/or be similar to, a communication interface 1210), and a memory 908 (which may include, and/or be similar to, a memory 1204). As shown, the memory 908 may store one or more inter fusion components 910, which may be executed by the processor(s) 904, to perform one or more of the processes described herein to fuse instances of metadata 112 associated with video segments.

Additionally, the memory 908 may store one or more intra fusion components 912, which may be executed by the processor(s) 904, to perform one or more fusion processes with respect to the individual instances of metadata 112. Examples of performing the fusion process(es) that are performed by the inter fusion component(s) 910 are described in detail within application Ser. No. 18/542,389, which is titled “Real-Time Object Tracking using Motion and Visual Characteristics for Intelligent Video Analytics Systems,” the entirety of which is incorporated herein by reference.

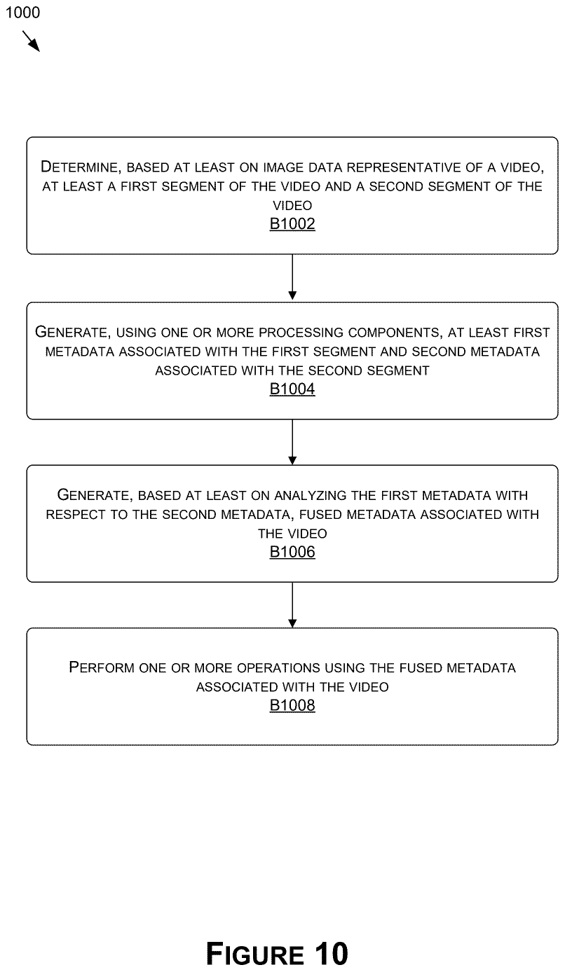

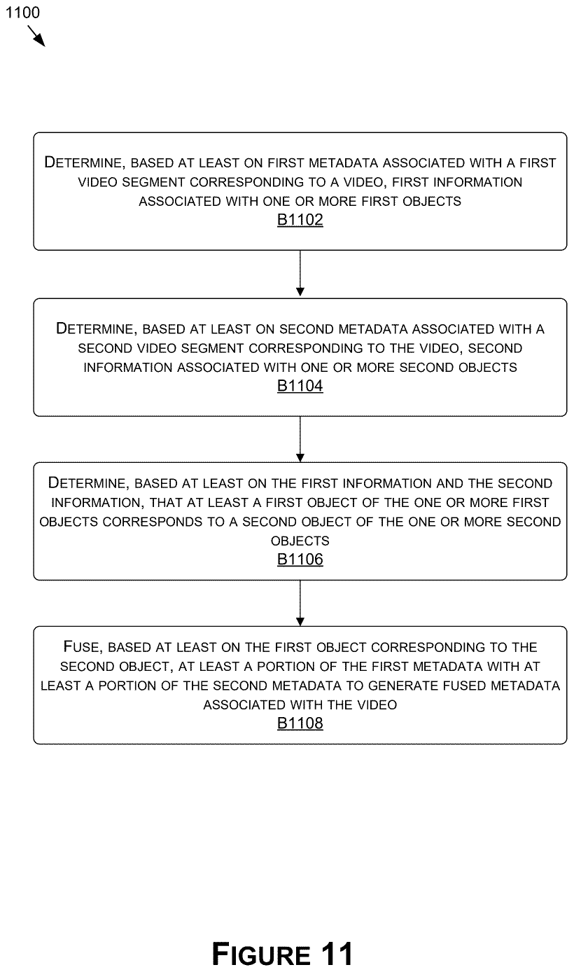

Now referring to FIGS. 10 and 11, each block of methods 1000 and 1100, described herein, comprises a computing process that may be performed using any combination of hardware, firmware, and/or software. For instance, various functions may be carried out by a processor executing instructions stored in memory. The methods 1000 and 1100 may also be embodied as computer-usable instructions stored on computer storage media. The methods 1000 and 1100 may be provided by a standalone application, a service or hosted service (standalone or in combination with another hosted service), or a plug-in to another product, to name a few. In addition, these methods 1000 and 1100 described, by way of example, with respect to FIG. 1. However, these methods 1000 and 1100 may additionally or alternatively be executed by any one system, or any combination of systems, including, but not limited to, those described herein.

FIG. 10 illustrates a flow diagram showing a method 1000 for generating video metadata using video segmentation and data fusion, in accordance with some embodiments of the present disclosure. The method 1000, at block B1002, may include determining, based at least on image data representative of a video, at least a first segment of the video and a second segment of the video. For instance, the segmentation component(s) 106 may process the image data 102 to generate at least the first video segment 108 and the second video segment 108 associated with the video. As described herein, the segmentation component(s) 106 may use one or more factors to perform the segmentation, such as a number of the processing component(s) 110 that may be used to process the video, one or more types of the processing component(s) 110, a desired latency associated with performing the processing, a prespecified number, and/or any other factor

The method 1000, a block B1004, may include generating, using one or more processing components, at least first metadata associated with the first segment and second metadata associated with the second segment. For instance, the processing component(s) 110 may then process the image data 102 representing the video segments 108 and generate at least the first metadata 112 associated with the first video segment 108 and the second metadata 112 associated with the second video segment 108. As described herein, an instance of metadata 112 may represent at least one or more identifiers for one or more objects, spatio-temporal information associated with the object(s), and/or visual information associated with the object(s).

The method 1000, at block B1006, may include generating, based at least on analyzing the first metadata with respect to the second metadata, fused metadata associated with the video. For instance, the fusion component(s) 124 may analyze the first metadata 112 with respect to the second metadata 112 to determine that one or more objects represented by the second metadata 112 include one or more objects represented by the first metadata 112. Based at least on that determination, the fusion component(s) 124 may then fuse the information from the first metadata 112 associated with the object(s) with the information from the second metadata 112 that is also associated with the object(s). The output from the fusion component(s) 124 may then include the fused metadata 126 that represents the fused information.

The method 1000, at block B1008, may include performing one or more operations using the fused metadata associated with the video. For instance, the fused metadata 126 may be further fused with one or more additional instances of metadata 112 associated with one or more additional video segments 108, the fused metadata 126 may be stored in the metadata database 128 in association with the video, the fused metadata 126 may be provided to one or more additional processing components for further processing, and/or any other process may be performed.

FIG. 11 illustrates a flow diagram showing a method 1100 for fusing instances of metadata associated with different video segments of a video, in accordance with some embodiments of the present disclosure. The method 1100, at block B1102, may include determining, based at least on first metadata associated with a first video segment corresponding to a video, first information associated with one or more first objects. For instance, the fusion component(s) 124 may determine the first information using the first metadata 112 associated with the first video segment 108. As described herein, the first information may include one or more first identifiers, first spatio-temporal information, and/or first visual information associated with the first object(s). Additionally, in some examples, the first information may be associated with one or more first tracklets associated with the first object(s).

The method 1100, at block B1104, may include determining, based at least on second metadata associated with a second video segment corresponding to the video, second information associated with one or more second objects. For instance, the fusion component(s) 124 may determine the second information using the second metadata 112 associated with the second video segment 108. As described herein, the second information may include one or more second identifiers, second spatio-temporal information, and/or second visual information associated with the second object(s). Additionally, in some examples, the second information may be associated with one or more second tracklets associated with the second object(s).

The method 1100, at block B1106, may include determining, based at least on the first information and the second information, that at least a first object of the one or more first objects corresponds to a second object of the one or more second objects. For instance, the fusion component(s) 124 may analyze the first information with respect to the second information to determine that the first object corresponds to the second object (e.g., includes a same object). As described herein, in some examples, the fusion component(s) 124 may determine that the first object corresponds to the second object by matching at least a portion of the second information to at least a portion of the first information. Additionally, or alternatively, in some examples, the fusion component(s) 124 may use the first information to determine projected information associated with the first object(s). The fusion component(s) 124 may then determine that the first object corresponds to the second object by matching at least a portion of the second information to at least a portion of the projected information.

The method 1100, at block B1108, may include fusing, based at least on the first object corresponding to the second object, at least a portion of the first metadata with at least a portion of the second metadata to generate fused metadata associated with the video. For instance, the fusion component(s) 124 may generate the fused metadata 126 associated with the video using at least the portion of the first metadata 112 that is associated with the same object and at least the portion of the second metadata 112 that is associated with the same object. As described herein, in some examples, the fusion component(s) 124 may generate the fused metadata 126 by fusing the portion of the first information associated with the first object with the portion of the second information associated with the second object.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: One or more processors comprising: processing circuitry to: determine first information for a first object as represented by first metadata associated with a first segment of a video and second information for a second object as represented by second metadata associated with a second segment of the video; determine, based at least on the first information and the second information, that the first object includes a same object as the second object; generate, based at least on the first object including the same object as the second object, third information associated with the object by interpolating between at least a first portion of the first information and at least a second portion of the second information; and storing fused metadata that represents at least the third information.

B: The one or more processors of paragraph A, wherein the third information comprises at least one of: a fused identity associated with the same object; fused location information associated with the same object; or fused visual information associated with the same object.

C: The one or more processors of either paragraph A or paragraph B, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

D: A method comprising: determining, using at least one of image data representative of a video or available processing capacity of one or more processing components for processing the image data, a partitioning of the video that includes at least a first segment of the video and a second segment of the video; generating, using the one or more processing components, at least first metadata associated with the first segment and second metadata associated with the second segment; generating, based at least on analyzing the first metadata with respect to the second metadata, fused metadata associated with the video; and storing, in one or more databases, the fused metadata associated with the video.

E: The method of paragraph D, wherein the determining the partitioning of the video comprises: determining the available processing capacity of the one or more processing components using at least one of a number of processing components of the one or more processing components or one or more types of processing components of the one or more processing components; determining, based at least on the available capacity, at least one of a number of segments or a segment length for partitioning the video; and determining, using at least one of the number of segments or the segment length, the partitioning of the video that includes at least the first segment and the second segment.

F: The method of either paragraph D or paragraph E wherein: the second segment of the video includes at least one or more images of the first segment of the video; and a first portion of the first metadata that is associated with the one or more images corresponds to a second portion of the second segment that is associated with the one or more images.

G: The method of any one of paragraphs D-F, wherein: the first metadata represents at least a first identifier for a first object depicted by the first segment of the video; the second metadata represents at least a second identifier for a second object depicted by the second segment of the video; and the generating the fused metadata comprises: determining that the first object from the first segment includes a same object as the second object from the second segment; and generating the fused metadata to represent the second identifier for the same object.

H: The method of paragraph G, wherein: the first metadata further represents at least one of first location information or first visual information associated with the first object as depicted by the first segment of the video; the second metadata further represents at least one of second location information or second visual information associated with the second object as depicted by the second segment of the video; and the determining that the first object includes the same object as the second object comprises: determining at least one of a first similarity score based at least on comparing the second location information to the first location information or a second similarity score based at least on comparing the second visual information to the first visual information; and determining that the first object includes the same object as the second object based at least on the at least one of the first similarity score or the second similarity score.

I: The method of paragraph G, wherein: the first metadata further represents at least one of first location information or first visual information associated with the first object as depicted by the first segment of the video; the second metadata further represents at least one of second location information or second visual information associated with the second object as depicted by the second segment of the video; and the method further comprises generating the fused metadata to further represent at least one of fused location information using the first location information and the second location information or fused visual information using the first visual information and the second visual information.

J: The method of any one of paragraphs D-I, wherein the second segment is sequentially after the first segment in the video, and wherein the method further comprises: determining, based on at least one of the image data or the available processing capacity of the one or more processing components for processing the image data, the partitioning to further include a third segment of the video; generating, using the one or more processing components, third metadata associated with the third segment; generating, based at least on analyzing the third metadata with respect to the fused metadata, second fused metadata associated with the video; and storing, in the one or more databases, the second fused metadata associated with the video.

K: The method of any one of paragraphs D-J, further comprising: determining, using at least one of the image data or the available processing capacity of the one or more processing components for processing the image data, the partitioning to further include a third segment of the video and a fourth segment of the video; generating, using the one or more processing components, at least third metadata associated with the third segment and fourth metadata associated with the fourth segment; generating, based at least on analyzing the third metadata with respect to the fourth metadata, second fused metadata associated with the video; generating, based at least on analyzing the second fused metadata with respect to the fused metadata, third fused metadata associated with the video; and storing, in the one or more databases, the third fused metadata associated with the video.

L: The method of any one of paragraphs D-K, wherein the generating of the first metadata and the second metadata comprises: generating the first metadata based at least on a first processing component of the one or more processing components processing a first portion of the image data that represents the first segment; and generating, at least partially in parallel with generating the first metadata, the second data based at least on a second processing component of the one or more processing components processing a second portion of the image data that represents the second segment, the second metadata.

M: A system comprising: one or more processors to: determine, using image data representative of a video, segments associated with the video; generate, using one or more processing components, instances of metadata associated with the segments; generate, based at least on analyzing the instances of metadata, fused metadata associated with the video; and store, in one or more databases, the fused metadata in association with the image data.

N: The system of paragraph M, wherein the one or more processors are further to: determine information associated with the one or more processing components, the information including at least a number of the one or more processing components or one or more types of the one or more processing components, wherein the segments associated with the video are determined based at least on the information.

O: The system of either paragraph M or paragraph N, wherein: the instances of metadata represent identifiers associated with an object as represented by the segments; and the generation of the fused metadata comprises: determining, based at least on the analyzing of the instances of metadata, that the object is represented by the segments; and generating, based at least on the object being represented by the segments, the fused metadata to represent at least an identifier of the identifiers associated with the object.

P: The system of any one of paragraphs M-O, wherein: the instances of metadata further represent at least one of instances of location information or instances of visual information associated with the object; and the determination that the object is represented by the segments comprises: determining at least one of a first similarity score based at least on the instances of location information or a second similarity score based at least on the instances of visual information; and determining that the object is represented by the segments based at least on the at least one of the first similarity score or the second similarity score.

Q: The system of any one of paragraphs M-P, wherein: the instances of metadata represent at least one of instances of location information or instances of visual information associated with an object; and the generation of the fused metadata comprises: determining, based at least on the analyzing of the instances of metadata, that the object is represented by the segments; and generating, based at least on the object being represented by the segments, the fused metadata to represent at least one of fused location information using the instances of location information or fused visual information using the instances of the visual information.

R: The system of any one of paragraphs M-Q, wherein the generation of the fused metadata comprises: determining that a first segment of the segments is sequential to a second segment of the segments and a third segment of the segments is sequential to the second segment; generating, based at least on analyzing a first instance of metadata associated with the first segment with respect to a second instance of metadata associated with the second segment, initial fused metadata; and generating, based at least on analyzing the initial fused metadata with respect to a third instance of metadata associated with the third segment, the fused metadata associated with the video.

S: The system of any one of paragraphs M-R, wherein the generation of the fused metadata comprises: generating, based at least on analyzing groups of the instances of metadata associated with groups of the segments, instances of initial fused metadata associated with the groups of the segments; and generating, based at least on analyzing the instances of initial fused metadata, the fused metadata associated with the video.

T: The system of any one of paragraphs M-S wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
determining, using at least one of image data representative of a video or available processing capacity of one or more processing components for processing the image data, a partitioning of the video that includes at least a first segment of the video and a second segment of the video;
generating, using the one or more processing components, at least first metadata associated with the first segment and second metadata associated with the second segment;
generating, based at least on analyzing the first metadata with respect to the second metadata, fused metadata associated with the video; and
storing, in one or more databases, the fused metadata associated with the video.

2. The method of claim 1, wherein the determining the partitioning of the video comprises:
determining the available processing capacity of the one or more processing components using at least one of a number of processing components of the one or more processing components or one or more types of processing components of the one or more processing components;
determining, based at least on the available capacity, at least one of a number of segments or a segment length for partitioning the video; and
determining, using at least one of the number of segments or the segment length, the partitioning of the video that includes at least the first segment and the second segment.

3. The method of claim 1, wherein:
the second segment of the video includes at least one or more images of the first segment of the video; and
a first portion of the first metadata that is associated with the one or more images corresponds to a second portion of the second segment that is associated with the one or more images.

4. The method of claim 1, wherein:
the first metadata represents at least a first identifier for a first object depicted by the first segment of the video;
the second metadata represents at least a second identifier for a second object depicted by the second segment of the video; and
the generating the fused metadata comprises:
determining that the first object from the first segment includes a same object as the second object from the second segment; and
generating the fused metadata to represent the second identifier for the same object.

5. The method of claim 4, wherein:
the first metadata further represents at least one of first location information or first visual information associated with the first object as depicted by the first segment of the video;
the second metadata further represents at least one of second location information or second visual information associated with the second object as depicted by the second segment of the video; and
the determining that the first object includes the same object as the second object comprises:
determining at least one of a first similarity score based at least on comparing the second location information to the first location information or a second similarity score based at least on comparing the second visual information to the first visual information; and
determining that the first object includes the same object as the second object based at least on the at least one of the first similarity score or the second similarity score.

6. The method of claim 4, wherein:
the first metadata further represents at least one of first location information or first visual information associated with the first object as depicted by the first segment of the video;
the second metadata further represents at least one of second location information or second visual information associated with the second object as depicted by the second segment of the video; and
the method further comprises generating the fused metadata to further represent at least one of fused location information using the first location information and the second location information or fused visual information using the first visual information and the second visual information.

7. The method of claim 1, wherein the second segment is sequentially after the first segment in the video, and wherein the method further comprises:
determining, based on at least one of the image data or the available processing capacity of the one or more processing components for processing the image data, the partitioning to further include a third segment of the video;
generating, using the one or more processing components, third metadata associated with the third segment;
generating, based at least on analyzing the third metadata with respect to the fused metadata, second fused metadata associated with the video; and
storing, in the one or more databases, the second fused metadata associated with the video.

8. The method of claim 1, further comprising:
determining, using at least one of the image data or the available processing capacity of the one or more processing components for processing the image data, the partitioning to further include a third segment of the video and a fourth segment of the video;
generating, using the one or more processing components, at least third metadata associated with the third segment and fourth metadata associated with the fourth segment;
generating, based at least on analyzing the third metadata with respect to the fourth metadata, second fused metadata associated with the video;
generating, based at least on analyzing the second fused metadata with respect to the fused metadata, third fused metadata associated with the video; and
storing, in the one or more databases, the third fused metadata associated with the video.

9. The method of claim 1, wherein the generating of the first metadata and the second metadata comprises:
generating the first metadata based at least on a first processing component of the one or more processing components processing a first portion of the image data that represents the first segment; and
generating, at least partially in parallel with generating the first metadata, the second data based at least on a second processing component of the one or more processing components processing a second portion of the image data that represents the second segment, the second metadata.

10. A system comprising:
one or more processors to:
determine, using image data representative of a video, segments associated with the video;
generate, using one or more processing components, instances of metadata associated with the segments;
generate, based at least on analyzing the instances of metadata, fused metadata associated with the video; and
store, in one or more databases, the fused metadata in association with the image data.

11. The system of claim 10, wherein the one or more processors are further to:
determine information associated with the one or more processing components, the information including at least a number of the one or more processing components or one or more types of the one or more processing components,
wherein the segments associated with the video are determined based at least on the information.

12. The system of claim 10, wherein:
the instances of metadata represent identifiers associated with an object as represented by the segments; and
the generation of the fused metadata comprises:
determining, based at least on the analyzing of the instances of metadata, that the object is represented by the segments; and
generating, based at least on the object being represented by the segments, the fused metadata to represent at least an identifier of the identifiers associated with the object.

13. The system of claim 12, wherein:
the instances of metadata further represent at least one of instances of location information or instances of visual information associated with the object; and
the determination that the object is represented by the segments comprises:
determining at least one of a first similarity score based at least on the instances of location information or a second similarity score based at least on the instances of visual information; and
determining that the object is represented by the segments based at least on the at least one of the first similarity score or the second similarity score.

14. The system of claim 10, wherein:
the instances of metadata represent at least one of instances of location information or instances of visual information associated with an object; and
the generation of the fused metadata comprises:
determining, based at least on the analyzing of the instances of metadata, that the object is represented by the segments; and
generating, based at least on the object being represented by the segments, the fused metadata to represent at least one of fused location information using the instances of location information or fused visual information using the instances of the visual information.

15. The system of claim 10, wherein the generation of the fused metadata comprises:
determining that a first segment of the segments is sequential to a second segment of the segments and a third segment of the segments is sequential to the second segment;
generating, based at least on analyzing a first instance of metadata associated with the first segment with respect to a second instance of metadata associated with the second segment, initial fused metadata; and
generating, based at least on analyzing the initial fused metadata with respect to a third instance of metadata associated with the third segment, the fused metadata associated with the video.

16. The system of claim 10, wherein the generation of the fused metadata comprises:
generating, based at least on analyzing groups of the instances of metadata associated with groups of the segments, instances of initial fused metadata associated with the groups of the segments; and
generating, based at least on analyzing the instances of initial fused metadata, the fused metadata associated with the video.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising:
processing circuitry to:
determine first information for a first object as represented by first metadata associated with a first segment of a video and second information for a second object as represented by second metadata associated with a second segment of the video;
determine, based at least on the first information and the second information, that the first object includes a same object as the second object;
generate, based at least on the first object including the same object as the second object, third information associated with the object by interpolating between at least a first portion of the first information and at least a second portion of the second information; and
storing fused metadata that represents at least the third information.

19. The one or more processors of claim 18, wherein the third information comprises at least one of:
a fused identity associated with the same object;
fused location information associated with the same object; or
fused visual information associated with the same object.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
